(19) United States
(12) Patent Application Publication
(10) Pub. No.: US 2020/0342176 A1
(43) Pub. Date: Oct. 29, 2020

(54) VARIABLE DATA GENERATING APPARATUS, PREDICTION MODEL GENERATING APPARATUS, VARIABLE DATA GENERATING METHOD, PREDICTION MODEL GENERATING METHOD, PROGRAM, AND RECORDING MEDIUM

(71) Applicant: NEC Solution Innovators, Ltd., Tokyo (JP)

(72) Inventor: Taketo KAWAMURA, Tokyo (JP)

(73) Assignee: NEC Solution Innovators, Ltd., Tokyo (JP)

(21) Appl. No.: 16/857,976

(22) Filed: Apr. 24, 2020

(30) Foreign Application Priority Data
Apr. 26, 2019 (JP) 2019-085733

(51) Int. Cl. G06F 40/30; G06F 40/247; G06F 40/279; G06F 40/268

(52) U.S. Cl. CPC G06F 40/30; G06F 40/268; G06F 40/279; G06F 40/247

(57) ABSTRACT

In a machine learning variable data generating apparatus 1, a text data obtaining unit 11 obtains text data, a variable group classifying unit 12 classifies the text data into a plurality of variable groups, a variable scoring unit 13 scores the data of at least one of the plurality of variable groups by associating that data with the data of another group, and a variable data output unit 14 takes the data of the scored group as a response variable and the data of the other group associated with the scored group as an explaining variable, and outputs those data.

### INCORPORATION BY REFERENCE

This application claims priority from Japanese Patent Application No. 2019-085733 filed on Apr. 26, 2019. The entire subject matter of the Japanese Patent Applications is incorporated herein by reference.

### TECHNICAL FIELD

The present invention relates to a variable data generating apparatus, a prediction model generating apparatus, a variable data generating method, a prediction model generating method, a program, and a recording medium.

### BACKGROUND ART

In recent years, the technique of machine learning has been advanced, and the machine learning has been used in the fields of automatic translation, speech recognition, image recognition (face recognition, etc.), and the like. Machine learning requires a large amount of learning data. For example, Patent Literature 1 discloses a system for suppressing the labor and cost required for collecting an enormous amount of information necessary for creating learning data for machine learning.

### CITATION LIST

### Patent Literature

Patent Literature 1: JP 2019-032857A

### SUMMARY

A machine learning variable data generating apparatus includes: a text data obtaining unit, a variable group classifying unit, a variable scoring unit, and a variable data output unit, wherein the text data obtaining unit obtains text data, the variable group classifying unit classifies the text data into a plurality of variable groups, the variable scoring unit scores the data of at least one of the plurality of variable groups by associating that data with the data of another group, and the variable data output unit takes the data of the scored group as a response variable, and the data of the other group associated with the scored group as an explaining variable, and outputs those data.

A variable data generating method includes: a text data obtaining step; a variable group classifying step; a variable scoring step, and a variable data output step, wherein the text data obtaining step obtains text data, the variable group classifying step classifies the text data into a plurality of variable groups, the variable scoring step scores the data of at least one of the plurality of variable groups by associating that data with the data of another group, and the variable data output step takes the data of the scored group as a response variable and the data of the other group associated with the scored group as an explaining variable, and outputs those data.

### BRIEF DESCRIPTION OF DRAWINGS

FIG. 1 is a block diagram illustrating the configuration of an example of an apparatus according to the Example Embodiment 1.

FIG. 2 is a block diagram illustrating an example of the hardware configuration of the apparatus according to the Example Embodiment 1.

FIG. 3 is a flowchart illustrating an example of processing performed in the apparatus according to the Example Embodiment 1.

FIG. 4 is a schematic diagram illustrating an example of a concept of a variable data generating apparatus and a prediction model generating apparatus according to the Example Embodiment 2.

FIG. 5 is a schematic diagram illustrating an example of a guide report in the apparatus according to the Example Embodiment 2.

FIG. 6 is a schematic diagram illustrating an example of a positive-negative table in the apparatus according to the Example Embodiment 2.

FIG. 7 is an example of the score table in which the response variable “guide” in the apparatus of the Example Embodiment 2 has been scored for each of visitors to Japan.

FIG. 8 is a schematic diagram illustrating an example of predicting a suitability from a prediction model in the apparatus according to the Example Embodiment 2.

FIG. 9 is a schematic diagram illustrating an example of predicting a suitability from a prediction model in the apparatus according to the Example Embodiment 2.

FIG. 10 is a schematic diagram illustrating an example of predicting a suitability from a prediction model in the apparatus according to the Example Embodiment 2.

FIG. 11 is a schematic diagram illustrating an example of predicting a suitability from a prediction model in the apparatus according to the Example Embodiment 2.

FIG. 12 is a chart illustrating an example of details of a recommendation in the apparatus according to the Example Embodiment 2.

### EXAMPLE EMBODIMENT

According to one aspect, in the variable data generating apparatus, the variable scoring unit may include a word-level evaluation reference table and a word extraction counting unit. The word-level evaluation reference table may include a level evaluation reference for each of words. The word extraction counting unit may extract, from the text data in the variable groups, a word in common with a word in the word-level evaluation reference table, and count the number of the extracted words. The variable scoring unit may score the data of the group on the basis of the counted number of the extracted words and the level evaluation reference in the word-level evaluation reference table.

In the variable data generating apparatus according to the stated aspect, the word extraction counting unit may extract, from the text data in the variable groups, a word in common with a word in the word-level evaluation reference table and a synonym of the word, and count the number of the extracted words.

In the variable data generating apparatus according to the stated aspect, the word extraction counting unit may further include a word vectorizing unit. The word vectorizing unit may vectorize a common word between the variable group text data and the word-level evaluation reference table. The word extraction counting unit may compare a vector of the common word with vectors of other words, and extract a synonym of the common word on the basis of a predetermined reference.

In the variable data generating apparatus according to the stated aspect, words in the word-level evaluation reference table may be vectorized by the word vectorizing unit. The word extraction counting unit may compare the vector of the common word with vectors of the words in the word-level evaluation reference table, and extract a synonym of the common word from the words in the word-level evaluation reference table on the basis of a predetermined reference.

According to one aspect, in the variable data generating apparatus, the variable scoring unit may include a word-level evaluation reference table generating unit. The word-level evaluation reference table generating unit may use morphological analysis to break down a plurality of Japanese text data obtained by the text data obtaining unit into words, extract a word in common with a word included in a Japanese sentiment polarity dictionary (volume of terms), and associate the extracted word with evaluation information for the word in the Japanese sentiment polarity dictionary in a table.

According to one aspect, in the variable data generating apparatus, the text data obtained by the text data obtaining unit may be travel detail data, traveler data, and travel guide data. The variable group classifying unit may classify the travel detail data as a travel detail variable, classify the traveler data as a traveler variable, and classify the travel guide data as a travel guide variable.

A prediction model generating apparatus includes: a variable data generating unit; a variable data input unit; a machine learning unit; and a prediction model output unit, wherein the variable data generating unit is the above-described variable data generating apparatus, the variable data input unit inputs response variable data and explaining variable data generated by the variable data generating unit to the machine learning unit, the machine learning unit generates, through machine learning, a prediction model, and the prediction model output unit outputs the generated prediction model.

According to one aspect, in the variable data generating method, the variable scoring step may include a word extraction counting step using a word-level evaluation reference table. The word-level evaluation reference table may include a level evaluation reference for each of words. The word extraction counting step may extract, from the text data in the variable groups, a word in common with a word in the word-level evaluation reference table, and count the number of the extracted words. The variable scoring step may score the data of the group on the basis of the counted number of the extracted words and the level evaluation reference in the word-level evaluation reference table.

In the variable data generating method according to the stated aspect, the word extraction counting step may extract, from the text data in the variable groups, a word in common with a word in the word-level evaluation reference table and a synonym of the word, and count the number of the extracted words.

In the variable data generating method according to the stated aspect, the word extraction counting step may further include a word vectorizing step. The word vectorizing step may vectorize a common word between the variable group text data and the word-level evaluation reference table. The word extraction counting step may compare a vector of the common word with vectors of other words, and extract a synonym of the common word on the basis of a predetermined reference.

In the variable data generating method according to the stated aspect, words in the word-level evaluation reference table may be vectorized by the word vectorizing step. The word extraction counting step may compare the vector of the common word with vectors of the words in the word-level evaluation reference table, and extract a synonym of the common word from the words in the word-level evaluation reference table on the basis of a predetermined reference.

According to one aspect, in the variable data generating method, the variable scoring step may include a word-level evaluation reference table generating step. The word-level evaluation reference table generating step may use morphological analysis to break down a plurality of Japanese text data obtained in the text data obtaining step into words, extract a word in common with a word included in a Japanese sentiment polarity dictionary (volume of terms), and associate the extracted word with evaluation information for the word in the Japanese sentiment polarity dictionary in a table.

According to one aspect, in the variable data generating method, the text data obtained in the text data obtaining step may be travel detail data, traveler data, and travel guide data. The variable group classifying step may classify the travel detail data as a travel detail variable, classify the traveler data as a traveler variable, and classify the travel guide data as a travel guide variable.

A prediction model generating method includes: a variable data generating step; a variable data input step; a machine learning step; and a prediction model output step, wherein the variable data generating step is performed by the above-described variable data generating method, the variable data input step inputs response variable data and explaining variable data generated in the variable data generating step to the machine learning step, the machine learning step generates, through machine learning, a prediction model, and the prediction model output step outputs the generated prediction model.

A program is a program configured to execute at least one of the variable data generating method and the prediction model generating method.

A recording medium is a computer-readable recording medium recorded with the above-described program.

Embodiments will be described next with reference to the drawings, but the invention is not intended to be limited to the following example embodiments. In the drawings, parts that are the same will be given the same reference signs. Furthermore, unless otherwise specified, the descriptions of individual embodiments can be applied to each other, and unless otherwise specified, the configurations described in the embodiments can be combined.

### Example Embodiment 1

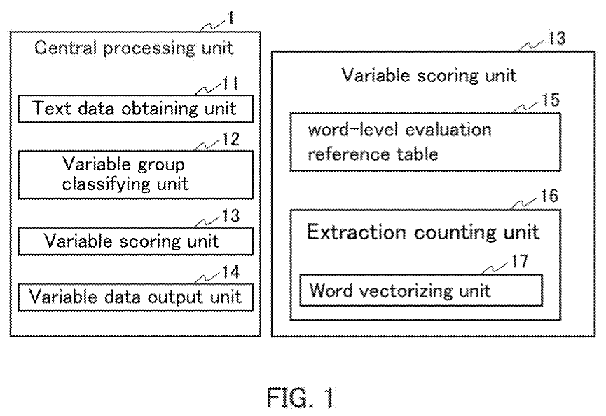

FIG. 1 is a block diagram illustrating the configuration of an example of a variable data generating apparatus 1 according to the present example embodiment. As illustrated in FIG. 1, the present apparatus 1 includes a text data obtaining unit 11, a variable group classifying unit 12, a variable scoring unit 13, and a variable data output unit 14. As illustrated in FIG. 1, the variable scoring unit 13 may include a word-level evaluation reference table 15 and a word extraction counting unit 16. The word extraction counting unit 16 may include a word vectorizing unit 17. The word vectorizing unit 17 is a unit configured to vectorize words and convert them into numerical data. For example, the word2vec can be used as the word vectorizing unit 17.

The form of the present apparatus 1 is not particularly limited, and a server, a personal computer (PC, e.g., a desktop PC or a laptop PC), and the like can be given as examples. In addition, the included units 11 to 17 of the present apparatus 1 may be in a form where individual apparatuses are connected via a network (a communication line network).

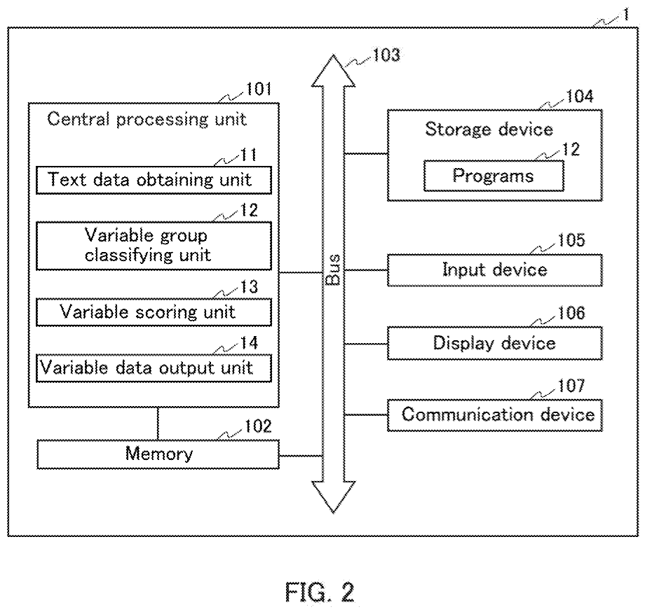

FIG. 2 is a block diagram illustrating an example of the hardware configuration of the present apparatus 1. The present apparatus 1 includes, for example, a central processing unit (CPU, GPU, or the like) 101, a memory 102, a bus 103, a storage device 104, an input device 105, a display device (display) 106, a communication device 107, and so on. The units of the present apparatus 1 are connected to each other by respective interfaces (I/Fs) via the bus 103.

The central processing unit 101 controls the present apparatus 1 as a whole. In the present apparatus 1, for example, the aforementioned program, other programs, and the like are executed, various types of information are read and written, and so on by the central processing unit 101. Specifically, the central processing unit 101 functions as the text data obtaining unit 11, the variable group classifying unit 12, the variable scoring unit 13, and the variable output unit 14, for example. Note that machine learning is carried out in the present apparatus 1, and the central processing unit 101 is therefore a GPU, for example.

The bus 103 can also connect to an external device, for example. An external storage device (an external database or the like), a printer, and so on can be given as examples of the external device. The present apparatus 1 can connect to an external network (communication line network) through the communication device 107 connected to the bus 103, for example, and can also connect to another apparatus or device via the external network. An administrator terminal (a PC, a server, a smartphone, a tablet, or the like) can be given as an example of the other apparatus.

The present apparatus 1 further includes the input device 105 and the display 106, for example. The input device 105 is a touch panel, a keyboard, a mouse, or the like, for example. An LED display, a liquid crystal display, and the like can be given as examples of the display 106.

In the present apparatus 1, the memory 102 and the storage device 104 can also store access information and log information from an administrator, as well as information obtained from an external database (not shown).

In the present apparatus 1, the text data obtaining unit 11 obtains text data over the external network through the communication device 107, for example. An Internet line, the World Wide Web (WWW), a telephone line, a local area network (LAN), delay tolerant networking (DTN), and the like can be given as examples of the external network. The communication by the communication device 107 may use a wire or be wireless. Wireless Fidelity (Wi-Fi), Bluetooth (registered trademark), and so on can be given as examples of wireless communication. A format in which apparatuses communicate directly with each other (ad-hoc communication) or communicate indirectly via an access point may be used for the wireless communication.

Main memory (a main storage device) can be given as an example of the memory 102. The main memory is random access memory (RAM), for example. The memory 102 may be read-only memory (ROM), for example. The storage device 104 may be a combination of a storage medium and a drive that reads from and writes to the storage medium, for example. The storage medium is not particularly limited, and may be either internal or external; a hard disk (HD), a CD-ROM, a CD-R, a CD-RW, a MO, a DVD, a flash memory, a memory card, and the like can be given as examples. The storage device 104 may be a hard disk drive (HDD) that integrates a storage medium with the drive, for example.

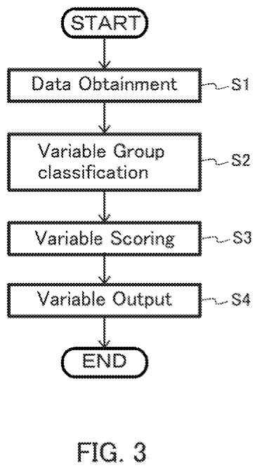

The flowchart in FIG. 3 illustrates an example of processing carried out by the present apparatus 1. First, the text data obtaining unit 11 obtains text data (S1). The variable group classifying unit 12 then classifies the text data into a plurality of variable groups (S2). The variable scoring unit 13 then scores the data of at least one of the plurality of variable groups by associating that data with the data of another group (S3). The variable data output unit 14 takes the data of the scored group as a response variable, and the data of the other group associated with the scored group as an explaining variable, and outputs those data (S4). When the response variable data and the explaining variable data output in the step S4 are input in the machine learning unit to be described below, the machine learning unit generates, through machine learning, a prediction model predicting a response variable from an explaining variable.

The machine learning is not particularly limited, and learning (deep learning) using decision trees, random forests, neural networks, or the like can be used, for example.

According to one aspect, in the variable data generating apparatus 1, the variable scoring unit 13 may include the word-level evaluation reference table 15 and the word extraction counting unit 16 as described above. The word-level evaluation reference table 15 includes a level evaluation reference for each of words. The word extraction counting unit 16 extracts, from the text data in the variable groups, a word in common with a word in the word-level evaluation reference table 15, and counts the number of the extracted words. The variable scoring unit 13 scores the data of the group on the basis of the counted number of the extracted words and the level evaluation reference in the word-level evaluation reference table 15. An example of scoring will be described in Example Embodiment 2.

According to one aspect, in the variable data generating apparatus 1, the word extraction counting unit 16 may extract, from the text data in the variable groups, a word in common with a word in the word-level evaluation reference table 15 and a synonym of the word, and count the number of the extracted words. In this case, according to one aspect, the word extraction counting unit 16 may further include the word vectorizing unit 17. In this case, according to one aspect, the word vectorizing unit 17 may vectorize (multidimensionally convert into numerical values) a common word between the variable group text data and the word-level evaluation reference table 15, and the word extraction counting unit 16 may compare a vector of the common word with vectors of other words, and extract a synonym of the common word on the basis of a predetermined reference.

As the word vectorizing unit 17, for example, the word2vec or the like can be used as described above. Hereinafter, vectorization of words will be described with reference to the word “fun”. The word vectorizing unit 17 calculates a feature amount based on, for example, the relationship between “fun” and co-occurrence words thereof, and determines the calculated feature amount as a vector of “fun”. That is, the vector is generated as a variance expression reflecting the definitions and semantic features of the word. Therefore, a word (synonym) similar to “fun” is determined as a vector similar to the vector.

Next, extraction of the synonym will be described with reference to Table 1 below. It is to be noted that, the following Table 1 is an example, and is not limited thereto. For extracting the synonym, for example, the word2vec or the like can be used in the same manner as described above.

TABLE 1

| Common | | Part of | | | Degree of |
|---|---|---|---|---|---|
| word | Synonym | speech | Adoption | Rank | similarity |
| Fun | Happiness | Noun | Root form | 1 | 0.556383967 |
| Fun | Fulfillment | Noun | Root form | 2 | 0.538022161 |
| Fun | Pleasant | Adjective | Root form | 3 | 0.537365794 |

The word “fun” in the Table 1 is a common word between the variable group text data and the word-level evaluation reference table 15. First, as described above, “fun” is vectorized by the word vectorizing unit 17. Next, the word extraction counting unit 16 compares the vector of “fun” with the vectors of other words. The other words are not particularly limited, and may be, for example, words in the word-level evaluation reference table 15 or words in an external database or the like. In the case of using the words in the word-level evaluation reference table 15, each word is vectorized by the word vectorizing unit 17. On the other hand, in the case of using the words in the external database or the like, each word may be vectorized by the word vectorizing unit 17.

Next, the word extraction counting unit 16 extracts synonyms (e.g., “happiness”, “fulfillment”, and “pleasant”) of “fun” based on a predetermined reference. When the other words are are words in the word-level evaluation reference table 15, the synonyms are extracted from the words in the word-level evaluation reference table. On the other hand, when the other words are words in an external database or the like, it is possible to extract words that are not present in the word-level evaluation reference table 15. The predetermined reference is not particularly limited, and may be, for example, a part of speech or the like. In the Table 1, the item “adoption” indicates whether or not the word is adopted as the synonym. In the Table 1, “happiness”, “fulfillment”, and “pleasant” are adopted as synonyms for “fun,” and the form of a part of speech of the adopted synonym is described in the item “adoption.” In the Table 1, the item “rank” indicates the order of words similar to “fun” based on the degree of similarity described below. Further, in the Table 1, the item “degree of similarity” indicates a value obtained by calculating the degree of similarity between the common word and each of the synonyms.

### Example Embodiment 2

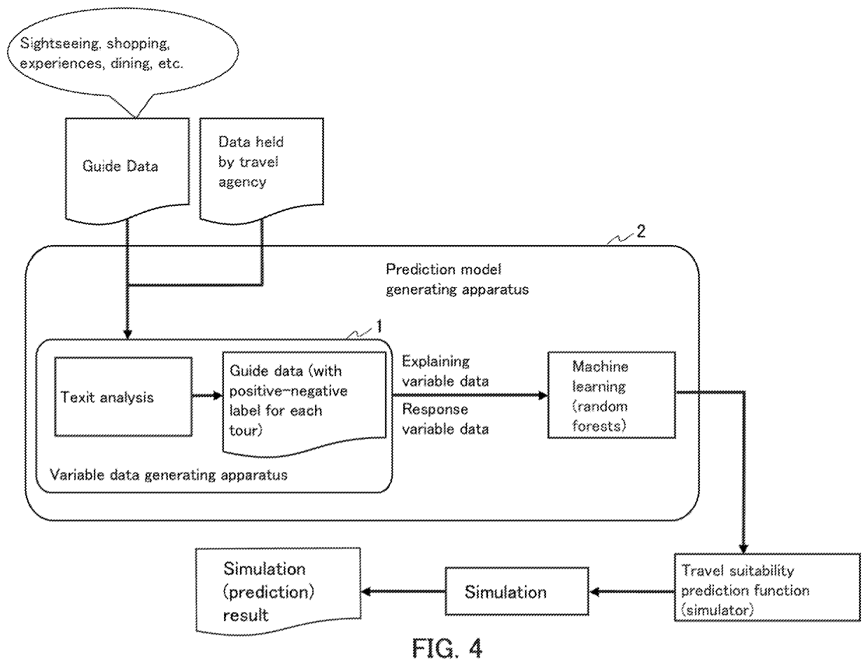

An example of a variable data generating apparatus 1 and a prediction model generating apparatus 2 will be described next with reference to FIGS. 4 to 12.

FIG. 4 illustrates a concept of the variable data generating apparatus 1 and the prediction model generating apparatus 2 that generates a prediction model using variable data generated in the variable data generating apparatus 1. In the concept illustrated in FIG. 4, guide data (e.g., guide report) is used as text data to generate variable data. As illustrated in FIG. 4, the text data obtaining unit 11 obtains guide data (text data from guide reports) and text data held by travel agencies, and the variable data generating apparatus 1 carries out text analysis (variable group classification and variable scoring). Guide report data such as sightseeing details, shopping, experiences (reviews), dining, and so on can be given as examples of the guide data. Data of travel details (destinations, transportation, periods, costs, and so on), guide data, traveler data, and so on can be given as examples of the data held by travel agencies.

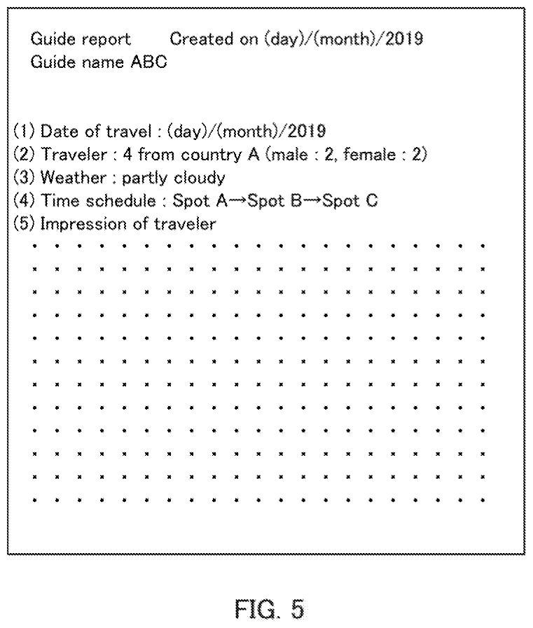

FIG. 5 illustrates an example of a guide report. As illustrated in FIG. 5, the guide report describes the date of creation, the name of the guide who created the guide report, the date of travel, the traveler (e.g., 4 from country A; male: 2; female: 2), the weather (partly cloudy, etc.), the time schedule (spots visited by the traveler, e.g., spot A, spot B, spot C, etc.), and the impression or feedback of the traveler (how the traveler felt or the impression of the traveler observed by the guide, etc.).

In the text analysis, for example, variable guide data with a positive-negative label is created for each of tours, on the basis of a positive-negative table (i.e., the word-level evaluation reference table 15). In this example, the variable guide data serves as a response variable.

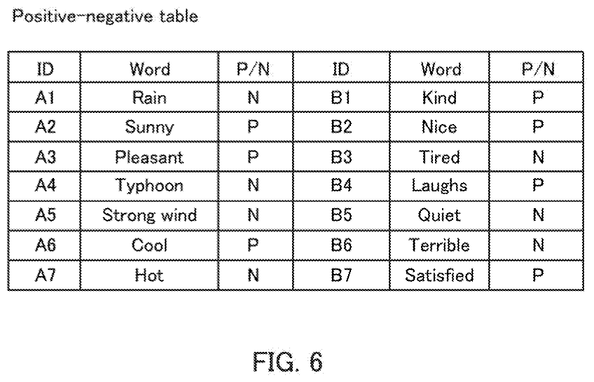

FIG. 6 illustrates an example of the positive-negative table. In FIG. 6, an identification sign (ID) is given to each of words, which are denoted as positive (P) or negative (N) and used as a reference for a positive-negative determination. For example, the word “rain”, with an ID of Al, is negative (N), whereas the word “sunny”, with an ID of A2, is positive (P). The synonym is a word similar to the common word. Therefore, even if the synonym is not described in the positive-negative table, a positive-negative determination can be made based on the common word. Although it is not illustrated in FIG. 6, for example, in the case where the word “fun” is positive in the positive-negative table, “happiness”, “fulfillment”, and “pleasant” which are synonyms of “fun” are also positive.

The word-level evaluation reference table may carry out a two-level evaluation as with the positive-negative table, but is not limited thereto, and may instead carry out a multi-level evaluation such as a three-level evaluation, a five-level evaluation, or the like.

The positive-negative table is not particularly limited, and may use, for example, the “Japanese Sentiment Polarity Dictionary (Volume of Terms)” (Nozomi Kobayashi, Kentaro Inui, Yuji Matsumoto, Kenji Tateishi, and Toshikazu Fukushima, Collecting Evaluative Expressions for Opinion Extraction, Journal of Natural Language Processing, Vol. 12, No. 3, pp. 203-222, 2005).

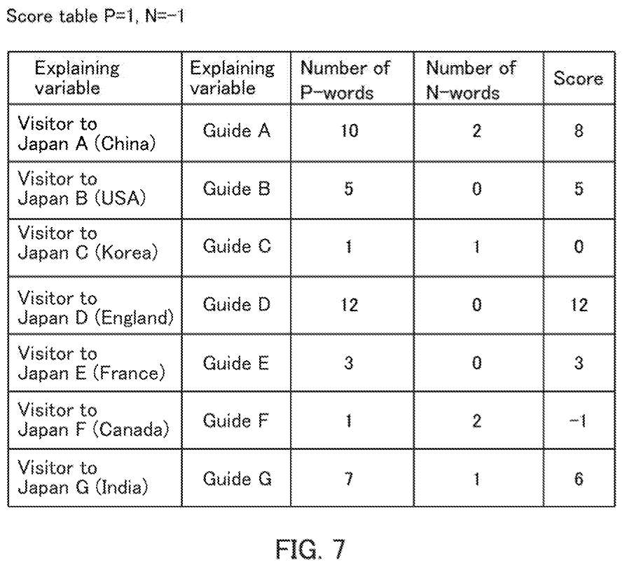

FIG. 7 illustrates a score table in which a response variable “guide” has been scored for each of visitors to Japan. As illustrated in FIG. 7, the score is calculated on the basis of the number of extracted words appearing in the guide data and the travel agency data, and an evaluation reference (P=1, N=−1). For example, guide A has a score of 8, which is a high evaluation for an associated visitor to Japan A (China). Meanwhile, guide F has a score of −1, which is a low evaluation (negative evaluation) for an associated visitor to Japan F (Canada). The data pertaining to visitors to Japan indicated in FIG. 7 serves as the “explaining variables”, the scored guide data serves as the response variables, and a prediction model can be generated by inputting these variables into the machine learning (a machine learning framework).

Next, the variable data generating apparatus 1 generates an explaining variable from the pre-text analysis guide data, as illustrated in FIG. 4. The guide data is constituted by information such as traveler information, guide information, tour execution information, and so on. This information is recorded as text data in a guide report, business report, or the like after a tour, for example. The explaining variables are information constituting the guide data and information that has not been converted to text. Specifically, nationality, age, gender, group makeup, preferences, number of visits, lodgings, dietary restrictions, and so on can be given as examples of the traveler information. Gender, age, whether or not the guide has guide interpreter qualifications, when qualifications were obtained, number of tours guided overall, and so on can be given as examples of the guide information. Tours, spots, guide dates and times, tour times, weather, temperature, spot evaluations, amount of money spent, consumables, services, and so on at the spots can be given as examples of the tour execution information. The explaining variables can be generated by, for example, detecting, from past data of the aforementioned examples of the explaining variables, information resulting in the greatest tour success (i.e., the highest score). The variable data generating apparatus 1 can generate explaining variables having a high impact on tour success by adding a feature flag to the detected information, for example.

In the present example, a spot classification may be added to the response variable (e.g., guide data having a positive-negative label for each tour). The “spot classification” is a classification that describes a spot. Adding a spot classification will be described using “Meiji Shrine” as an example of a spot. When adding a spot classification, words are extracted by carrying out morphological analysis on a descriptive passage of Meiji Shrine. A word aside from “Meiji Shrine”, which is the same of the spot, that appears frequently in the extracted words (e.g., “shrine” or the like) is then added as the spot classification. The descriptive passage may be information obtained from a website, for example, and a plurality of descriptive passages may be obtained.

Although not illustrated, open data may also be added to the explaining variables as additional information. “Open data” is data that can be freely collected from websites, for example, and includes the date and time, weekdays or holidays, local weather, local temperature, length of the day (sunrise and sunset times), and so on at the time of the tour execution. This open data is sometimes useful as explaining variables.

As illustrated in FIG. 4, the prediction model can be generated by inputting the response variables and explaining variables into a machine learning framework (e.g., random forests). An open source framework may be used as the machine learning framework. Additionally, a recommendation function may be employed in the present example. Collaborative filtering can be given as an example of the recommendation function. The travel suitability predicting apparatus provided with the prediction model is then generated. When data pertaining to an explaining function is input, the travel suitability predicting apparatus predicts (simulates) a suitability and outputs a simulation (prediction) result. At this time, when the travel suitability predicting apparatus is provided with the recommendation function, the simulation result may be output with the recommendation of suitability having been ranked.

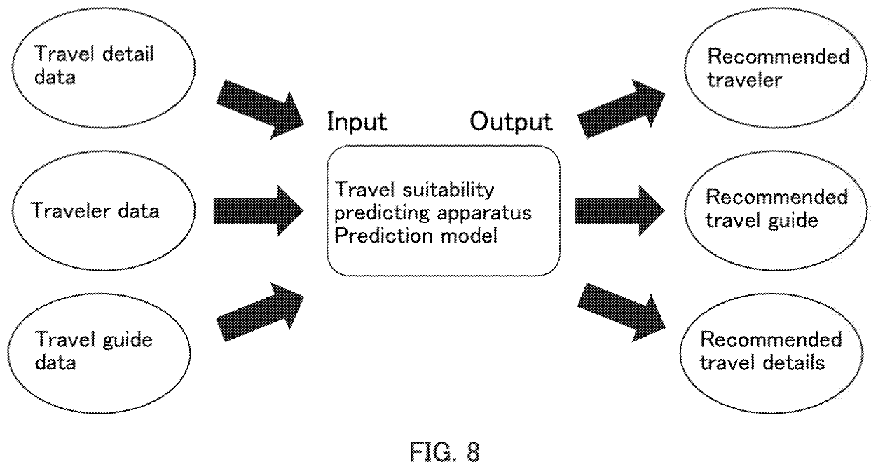

If, for example, at least one of travel detail data, traveler data, and travel guide data is taken as the response variable, other data is taken as the explaining variables, and three respective instances of machine learning are carried out, the prediction model generating apparatus generates three prediction models. If the three prediction models are then provided in the travel suitability predicting apparatus, a three-direction prediction (simulation) can be made, as illustrated in FIG. 8. With the travel suitability predicting apparatus according to this example, for example, if travel detail data is input, at least one of a recommended traveler and a recommended travel guide is output; if traveler data is input, at least one of recommended travel details and a recommended travel guide is output; and if travel guide data is input, at least one of a recommended traveler and recommended travel details is output. Thus, the travel suitability predicting apparatus according to this example can be used effectively by travelers, travel guides, and travel providers (travel agencies).

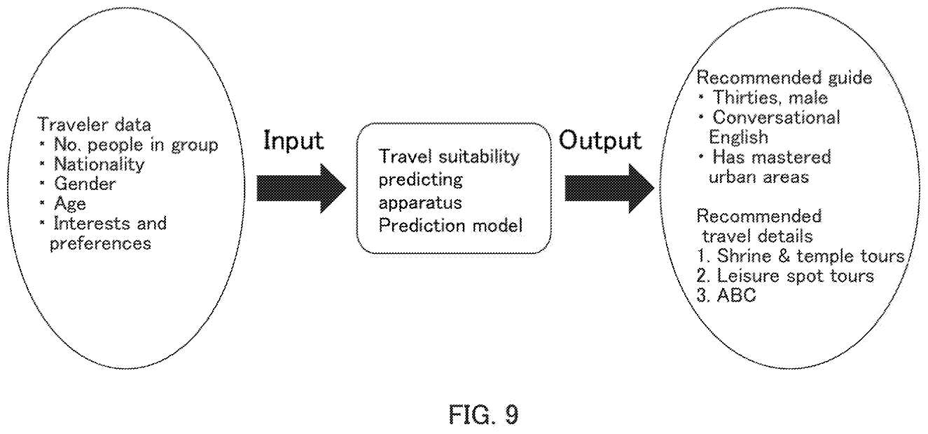

FIG. 9 is an example in which traveler data has been input as the input data. If the traveler data such as the number of people in group, the country of origin, gender, age, interests and preferences, or the like is input to the travel suitability predicting apparatus, a recommended guide and recommended travel details are output.

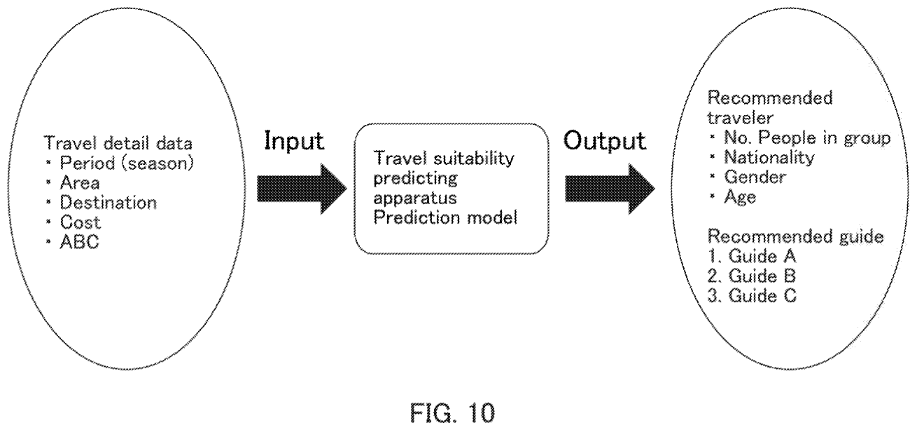

FIG. 10 is an example in which travel detail data has been input as the input data. If the travel detail data such as a period (season), an area, a destination, cost, or the like is input to the travel suitability predicting apparatus, a recommended traveler and a recommended travel guide are output.

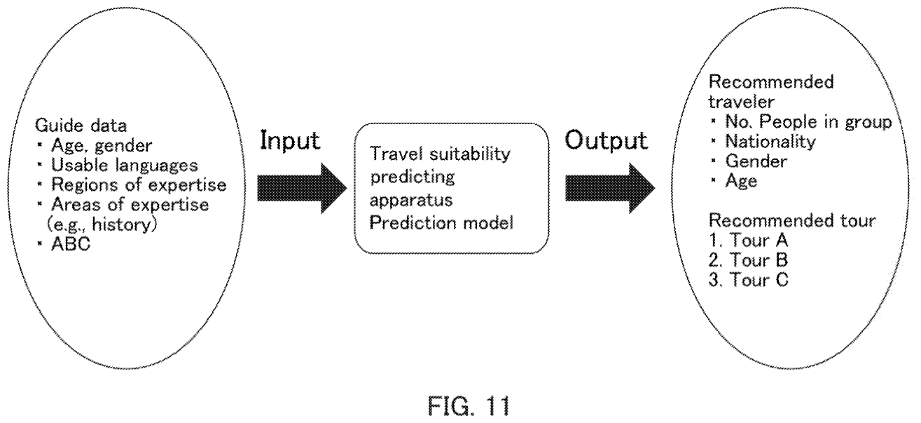

FIG. 11 is an example in which guide data has been input as the input data. If the guide data such as age, gender, usable language, the regions of expertise, the fields of expertise (e.g., history), whether or not the guide has guide interpreter qualifications, when qualifications were obtained, number of tours guided overall, or the like is input to the travel suitability predicting apparatus, a recommended traveler and recommended travel details are output.

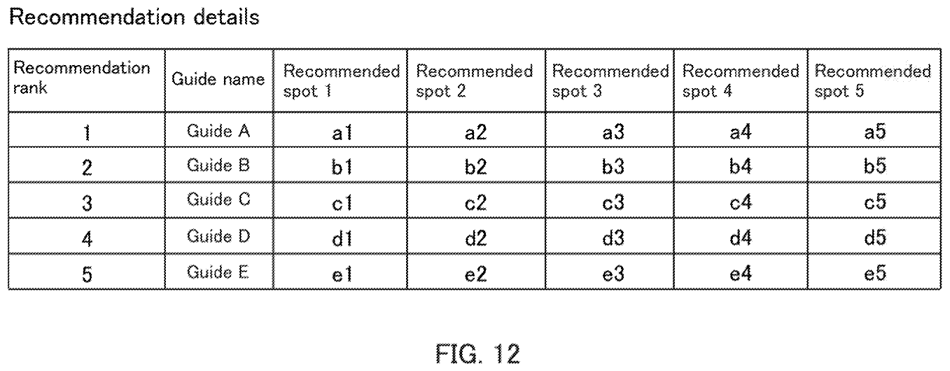

FIG. 12 illustrates the details of a recommendation to the travelers in a prediction result output by the travel suitability predicting apparatus according to this example. As illustrated in FIG. 12, recommended guides are ranked from first to fifth, and recommended spots (destinations) are ranked from first to fifth for each of the recommended guides. Although it is not illustrated in FIG. 12, according to the travel suitability predicting apparatus of the present example, as in the case of the recommended spot, information such as tour (combination of spots), weather, temperature, tour time, and time to visit the spot can also be recommended. The travel suitability predicting apparatus of the present example may recommend the recommendable information alone or in combination. In addition to the output of the recommended guide A or the like, it is also possible to output the guide data suitable for implementing the recommended guide or the like. The guide data is, for example, the same as described above. The output of the prediction result can be output not only from the traveler base point as illustrated in FIG. 12, but also from, for example, a spot or a guide as a base point. As the spot base point, for example, the rank of the recommended traveler, the rank of the tour guide, and the like with which the degree of satisfaction increases with respect to the spot are output. On the other hand, as the guide base point, for example, the rank of recommended traveler, the rank of tour spot, and the like having good compatibility with the guide are output.

It will be obvious to those having skill in the art that many changes may be made in the above-described details of the particular aspects described herein without departing from the spirit or scope of the invention as defined in the appended claims.

Supplementary Notes

The whole or part of the exemplary embodiments disclosed above can be described as, but not limited to, the following supplementary notes.

### (Supplementary Note 1)

A machine learning variable data generating apparatus includes: a text data obtaining unit, a variable group classifying unit, a variable scoring unit, and a variable data output unit, wherein

the text data obtaining unit obtains text data,

the variable group classifying unit classifies the text data into a plurality of variable groups,

the variable scoring unit scores the data of at least one of the plurality of variable groups by associating that data with the data of another group, and

the variable data output unit takes the data of the scored group as a response variable and the data of the other group associated with the scored group as an explaining variable, and outputs those data.

### (Supplementary Note 2)

The variable data generating apparatus according to Supplemental Note 1, wherein

the variable scoring unit includes a word-level evaluation reference table and a word extraction counting unit,

the word-level evaluation reference table includes a level evaluation reference for each of words,

the word extraction counting unit extracts, from the text data in the variable groups, a word in common with a word in the word-level evaluation reference table, and counts the number of the extracted words, and

the variable scoring unit scores the data of the group on the basis of the counted number of the extracted words and the level evaluation reference in the word-level evaluation reference table.

### (Supplementary Note 3)

The variable data generating apparatus according to Supplementary Note 2, wherein

the word extraction counting unit extracts, from the text data in the variable groups, a word in common with a word in the word-level evaluation reference table and a synonym of the word, and counts the number of the extracted words.

### (Supplementary Note 4)

The variable data generating apparatus according to Supplementary Note 3, wherein

the word extraction counting unit further includes a word vectorizing unit,

the word vectorizing unit vectorizes a common word between the variable group text data and the word-level evaluation reference table, and

the word extraction counting unit compares a vector of the common word with vectors of other words, and extracts a synonym of the common word on the basis of a predetermined reference.

### (Supplementary Note 5)

The variable data generating apparatus according to Supplementary Note 4, wherein

words in the word-level evaluation reference table are vectorized by the word vectorizing unit, and

the word extraction counting unit compares the vector of the common word with vectors of the words in the word-level evaluation reference table, and extracts a synonym of the common word from the words in the word-level evaluation reference table on the basis of a predetermined reference.

### (Supplementary Note 6)

The variable data generating apparatus according to any one of Supplementary Notes 1 to 5, wherein

the variable scoring unit includes a word-level evaluation reference table generating unit,

the word-level evaluation reference table generating unit uses morphological analysis to break down a plurality of Japanese text data obtained by the text data obtaining unit into words, and extracts a word in common with a word included in a Japanese sentiment polarity dictionary (volume of terms), and associates the extracted word with evaluation information for the word in the Japanese sentiment polarity dictionary in a table.

### (Supplementary Note 7)

The variable data generating apparatus according to any one of Supplementary Notes 1 to 6, wherein

the text data obtained by the text data obtaining unit is travel detail data, traveler data, and travel guide data, and

the variable group classifying unit classifies the travel detail data as a travel detail variable, classifies the traveler data as a traveler variable, and classifies the travel guide data as a travel guide variable.

### (Supplementary Note 8)

A prediction model generating apparatus includes: a variable data generating unit; a variable data input unit; a machine learning unit; and a prediction model output unit, wherein

the variable data generating unit is the variable data generating apparatus according to any one of Supplementary Notes 1 to 7,

the variable data input unit inputs response variable data and explaining variable data generated by the variable data generating unit to the machine learning unit,

the machine learning unit generates, through machine learning, a prediction model, and

the prediction model output unit outputs the generated prediction model.

### (Supplementary Note 9)

A machine learning variable data generating method includes: a text data obtaining step; a variable group classifying step; a variable scoring step, and a variable data output step, wherein

the text data obtaining step obtains text data,

the variable group classifying step classifies the text data into a plurality of variable groups,

the variable scoring step scores the data of at least one of the plurality of variable groups by associating that data with the data of another group, and

the variable data output step takes the data of the scored group as a response variable and the data of the other group associated with the scored group as an explaining variable, and outputs those data.

### (Supplementary Note 10)

The variable data generating method according to Supplementary Note 9, wherein

the variable scoring step includes a word extraction counting step using a word-level evaluation reference table,

the word-level evaluation reference table includes a level evaluation reference for each of words,

the word extraction counting step extracts, from the text data in the variable groups, a word in common with a word in the word-level evaluation reference table, and counts the number of the extracted words, and

the variable scoring step scores the data of the group on the basis of the counted number of the extracted words and the level evaluation reference in the word-level evaluation reference table.

### (Supplementary Note 11)

The variable data generating method according to Supplementary Note 10, wherein

the word extraction counting step extracts, from the text data in the variable groups, a word in common with a word in the word-level evaluation reference table and a synonym of the word, and counts the number of the extracted words.

### (Supplementary Note 12)

The variable data generating method according to Supplementary Note 11, wherein

the word extraction counting step further includes a word vectorizing step,

the word vectorizing step vectorizes a common word between the variable group text data and the word-level evaluation reference table, and

the word extraction counting step compares a vector of the common word with vectors of other words, and extracts a synonym of the common word on the basis of a predetermined reference.

### (Supplementary Note 13)

The variable data generating method according to Supplementary Note 12, wherein

words in the word-level evaluation reference table are vectorized by the word vectorizing step, and

the word extraction counting step compares the vector of the common word with vectors of the words in the word-level evaluation reference table, and extracts a synonym of the common word from the words in the word-level evaluation reference table on the basis of a predetermined reference.

### (Supplementary Note 14)

The variable data generating method according to any one of Supplementary Notes 9 to 13, wherein

the variable scoring step includes a word-level evaluation reference table generating step, and

the word-level evaluation reference table generating step uses morphological analysis to break down a plurality of Japanese text data obtained in the text data obtaining step into words, and extracts a word in common with a word included in a Japanese sentiment polarity dictionary (volume of terms), and associates the extracted word with evaluation information for the word in the Japanese sentiment polarity dictionary in a table.

### (Supplementary Note 15)

The variable data generating method according to any one of Supplementary Notes 9 to 14, wherein

the text data obtained in the text data obtaining step is travel detail data, traveler data, and travel guide data, and

the variable group classifying step classifies the travel detail data as a travel detail variable, classifies the traveler data as a traveler variable, and classifies the travel guide data as a travel guide variable.

### (Supplementary Note 16)

A prediction model generating method includes: a variable data generating step; a variable data input step; a machine learning step; and a prediction model output step, wherein

the variable data generating step is performed by the variable data generating method according to any one of Supplementary Notes 9 to 15,

the variable data input step inputs response variable data and explaining variable data generated in the variable data generating step to the machine learning step,

the machine learning step generates, through machine learning, a prediction model, and

the prediction model output step outputs the generated prediction model.

### (Supplementary Note 17)

A program configured to execute the method according to any one of Supplementary Notes 9 to 16.

### (Supplementary Note 18)

A computer-readable recording medium recorded with the program according to Supplementary Note 17.

1. A machine learning variable data generating apparatus comprising at least one processor configured to:
obtain text data,
classify the text data into a plurality of variable groups,
score the data of at least one of the plurality of variable groups by associating that data with the data of another group, and
take the data of the scored group as a response variable and the data of the other group associated with the scored group as an explaining variable, and output those data.

2. The variable data generating apparatus according to claim 1, wherein the processor is further configured to:
include a word-level evaluation reference table that includes a level evaluation reference for each of words,
extract, from the text data in the variable groups, a word in common with a word in the word-level evaluation reference table, and count the number of the extracted words, and
score the data of the group on the basis of the counted number of the extracted words and the level evaluation reference in the word-level evaluation reference table.

3. The variable data generating apparatus according to claim 2, wherein the processor is configured to:
extract, from the text data in the variable groups, a word in common with a word in the word-level evaluation reference table and a synonym of the word, and count the number of the extracted words.

4. The variable data generating apparatus according to claim 3, wherein the processor is further configured to:
vectorize a common word between the variable group text data and the word-level evaluation reference table, and
compare a vector of the common word with vectors of other words, and extract a synonym of the common word on the basis of a predetermined reference.

5. The variable data generating apparatus according to claim 4, wherein
words in the word-level evaluation reference table are vectorized by the processor, and
the processor is configured to compare the vector of the common word with vectors of the words in the word-level evaluation reference table, and extract a synonym of the common word from the words in the word-level evaluation reference table on the basis of a predetermined reference.

6. The variable data generating apparatus according to claim 1, wherein the processor is further configured to:
use morphological analysis to break down a plurality of Japanese text data obtained into words, and extract a word in common with a word included in a Japanese sentiment polarity dictionary (volume of terms), and
associate the extracted word with evaluation information for the word in the Japanese sentiment polarity dictionary in a table.

7. The variable data generating apparatus according to claim 1, wherein
the text data obtained is travel detail data, traveler data, and travel guide data, and
the processor is configured to classify the travel detail data as a travel detail variable, classify the traveler data as a traveler variable, and classify the travel guide data as a travel guide variable.

8. A machine learning variable data generating method comprising:
obtaining text data,
classifying the text data into a plurality of variable groups,
scoring the data of at least one of the plurality of variable groups by associating that data with the data of another group, and
taking the data of the scored group as a response variable, and the data of the other group associated with the scored group as an explaining variable, and outputting those data.

9. The variable data generating method according to claim 8 comprising:
extracting, from the text data in the variable groups, a word in common with a word in a word-level evaluation reference table, and counting the number of the extracted words, the word-level evaluation reference table including a level evaluation reference for each of words, and
scoring the data of the group on the basis of the counted number of the extracted words and the level evaluation reference in the word-level evaluation reference table.

10. The variable data generating method according to claim 9 comprising:
extracting, from the text data in the variable groups, a word in common with a word in the word-level evaluation reference table and a synonym of the word, and counts the number of the extracted words.

11. The variable data generating method according to claim 10 comprising:
vectorizing a common word between the variable group text data and the word-level evaluation reference table; and
comparing a vector of the common word with vectors of other words, and extracting a synonym of the common word on the basis of a predetermined reference.

12. The variable data generating method according to claim 11, wherein
words in the word-level evaluation reference table are vectorized, and
the method comprises: comparing the vector of the common word with vectors of the words in the word-level evaluation reference table, and extracting a synonym of the common word from the words in the word-level evaluation reference table on the basis of a predetermined reference.

13. The variable data generating method according to claim 8, comprising
using morphological analysis to break down a plurality of Japanese text data obtained into words, and extracting a word in common with a word included in a Japanese sentiment polarity dictionary (volume of terms), and
associating the extracted word with evaluation information for the word in the Japanese sentiment polarity dictionary in a table.

14. The variable data generating method according to claim 8, wherein
the text data obtained is travel detail data, traveler data, and travel guide data, and
the method comprises: classifying the travel detail data as a travel detail variable, classifying the traveler data as a traveler variable, and classifying the travel guide data as a travel guide variable.

15. A non-transitory computer-readable recording medium comprising a program; wherein
the program is configured to execute the method according to claim 8.
